(19) United States
(12) Patent Application Publication
(10) Pub. No.: US 2023/0397141 A1
(43) Pub. Date: Dec. 7, 2023

(54) METHOD AND APPARATUS FOR SYNCHRONISING APPARATUSES OF A WIRELESS NETWORK

(71) Applicant: CANON KABUSHIKI KAISHA, Tokyo (JP)

(72) Inventors: Yacine EL KOLLI, RENNES (FR); Romain GUIGNARD, RENNES (FR)

(21) Appl. No.: 18/249,136

(22) PCT Filed: Oct. 14, 2021
(86) PCT No.: PCT/EP2021/078407

§ 371 Date: Apr. 14, 2023

(30) Foreign Application Priority Data
Oct. 16, 2020 (GB) 2016494.3
Apr. 30, 2021 (GB) 2106275.7

(51) Int. Cl. H04W 56/00

(52) U.S. Cl. CPC H04W 56/0045

(57) ABSTRACT

The present invention concerns a method of updating a time counter of one user equipment in a wireless network comprising at least one base station and a plurality of user equipment, the method comprising at the user equipment:
receiving a timing advance command from the base station;
wherein in response to receiving the timing advance command,
updating the time counter using the timing advance command.

### FIELD OF THE INVENTION

The present disclosure concerns a method and a device for synchronising the apparatuses of a wireless network, such as radio communication network.

### BACKGROUND OF INVENTION

The uses of the Internet of Things, IoT, are multiplying, each use being accompanied by particular constraints.

One use of IoT is in the industry, for example in production plants using critical machines and a plurality of sensors and actuators. IoT makes it possible, for example, to precisely track a production line by implementing the following functions (non-exhaustive list): predictive maintenance (avoiding production interruptions by identifying early warning signs of failures to proactively schedule maintenance intervention), intelligent diagnostics (by recording operational data and repair history through sensors), production line optimisation, production machines optimisation, etc.

With the development of 5G technology, a new generation of IoT is developing. However, it is still necessary to ensure that 5G network is compatible with time sensitive applications implemented by IoT elements.

To do that, an accurate time synchronisation is required within the 5G network. One reason for desynchronisation despite the conventional reference system frames is the propagation delay. Indeed, the propagation delay, i.e. the time taken for a frame, such as a reference system frame, to reach its destination, may induce desynchronisation between the user equipment and a base station when the base station provides the user equipment with information for synchronisation, such as a reference time linked to the occurrence of a reference system frame.

Today, one mechanism to improve the synchronisation based on the reference system frames is proposed in the standard, in TS 38.211 clause 4.3, and is called Timing Advance Mechanism. This mechanism aims at controlling the timing of the user equipment's uplink frames.

This mechanism provides timing values within a Timing Advance (TA) command per user equipment which consider the propagation delay estimated for the user equipment.

To do that, the base station regularly monitors the propagation delay of the uplink frames, as it knows the times of the sending of the uplink frames and their estimated times of arrival given a first estimated propagation delay (already shared with the UE). The base station then compares the expected time of arrival with the effective time of arrival, in order to detect a significant increase in the propagation delay compared to the first estimated one.

When a significant increase is identified, the base station sends a TA command to the user equipment in order to provide updated parameters.

The user equipment registers the parameters of the command, calculates an updated propagation delay and waits for the next reference system frame. Upon receiving the next reference system frame, the user equipment determines an updated time counter based on the last calculated propagation delay.

However, this mechanism has limitations.

In particular, since the last TA command has been received, network conditions and the position of the user equipment may have changed. In this case, the parameters of the last TA command received no longer reflect the true propagation delay accurately. Such a situation induces desynchronisation of the time counter of the user equipment that will last until a new reference time is sent from the base station.

There is thus a needed for a more accurate synchronisation mechanism.

### SUMMARY OF THE INVENTION

The present invention has been devised to address one or more of the foregoing concerns. It concerns a mechanism for updating a time counter of a user equipment UE, such that, in response to receiving a timing advance command from the base station, the user equipment updates the time counter of the user equipment using the timing advance command.

According to a first aspect of the invention there is provided a method of updating a time counter of one user equipment in a wireless network comprising at least one base station and a plurality of user equipment, the method comprising at the user equipment:

receiving a timing advance command from the base station;

wherein in response to receiving the timing advance command,

updating the time counter using the timing advance command.

In that way, there is no longer the need for the UE to wait for the next reference system frame before adjusting its time counter based on a received TA command. Should the TA command be received soon after the prior art time counter adjustment, the time counter adjustment in response to the TA command indeed accurately mirrors the true propagation delay given the current UE location and network conditions.

Thus, the invention enables the UE to take into consideration a TA command as soon as it is received, even after the conventional update of the time counter of the UE, to calculate the propagation delay and to use the calculated value of the propagation delay for adjusting the time counter of the UE.

Correspondingly, the invention provides a user equipment of a wireless network comprising a processor configured to:

receiving a timing advance command from the base station;

wherein in response to receiving the timing advance command,

updating the time counter using the timing advance command.

The user equipment has the same advantages as the method defined above.

Optional features of the invention are defined in the appended claims. Some of these features are explained here below with reference to a method, while they can be transposed into system features dedicated to a user equipment of a wireless network according to the invention.

According to some embodiments, the timing advance command may include a parameter representative of a propagation delay between the base station and the user equipment.

According to some embodiments, the method may further comprise:

receiving a previous timing advance command from the base station;

receiving a reference system frame emitted by the base station; and

responsive to receiving the reference system frame, updating the time counter using the previous timing advance command, to obtain a previously updated time counter,

wherein the updating of the time counter using the timing advance command includes updating the previously updated time counter based on the timing advance command.

According to some embodiments, the method may further comprise:

determining whether the timing advance command is more accurate than the previous timing advance command, based on a comparison criterion, and

triggering the updating of the time counter using the timing advance command, in case of positive determining.

According to some embodiments, determining whether the timing advance command is more accurate than the previous timing advance command may comprise:

comparing a first elapsed time between the reference system frame and the previous timing advance command and a second elapsed time between the reference system frame and the timing advance command.

According to some embodiments, the method may further comprise:

receiving a reference time corresponding to the reference system frame,

determining whether the received reference time is a compensated reference time representing an arrival time of the reference system frame at the user equipment, said compensated reference time already including a value of a propagation delay,

wherein the time counter is updated further based on the compensated reference time.

According to some embodiments, in case of positive determining, the method may comprise:

performing the updating of the time counter using the timing advance command, independently to the previous timing advance command.

According to some embodiments, in case of negative determining, the method may further comprise:

determining whether the timing advance command is more accurate than the previous timing advance command, based on a comparison criterion, and

triggering the updating of the time counter using the timing advance command, in case of positive determining that the timing advance command is more accurate.

According to some embodiments, the timing advance command used to update the time counter may be the first timing advance command received after the reference system frame.

According to some embodiments, the timing advance command may be received through a Protocol Data Unit from the group of Random Access Response MAC Protocol Data Unit, Absolute Timing Advance Command MAC Control Element, Timing Advance Command MAC Control Element, all defined in TS 38.321, and a Control Element compliant with the MAC Control Element format described in TS 38.321, which comprises a command field of at least 13 bits to encode the timing advance command.

However, the encoding of the TA command as specified in TS 38.321 introduces an error due to the granularity of the represented path delay information.

Changing the encoding of the transported TA command is one way to reduce the error caused by the TA indication granularity.

Another way is to perform the path delay compensation by the gNB, this way the TA command is not transported prior to its usage for path delay compensation and TA indication error is null.

According to another aspect of the invention there is provided a method of updating a time counter of one user equipment in a wireless network comprising at least one base station and a plurality of user equipment, the method comprising at the base station:

estimating a propagation delay with the user equipment;

determining a compensated reference time representing an arrival time of an associated reference system frame at the user equipment, said compensated reference time including the propagation delay;

sending the compensated reference time and the associated reference system frame to said user equipment, for updating the time counter.

Thus, the compensated reference time includes the propagation delay specific to the user equipment in order to allow the time counter of the user equipment to be directly updated without calculating a propagation delay. In other words, the proposed embodiment aims at integrating the propagation delay in the reference time value provided by the gNB for updating the time counter of the user equipment.

Correspondingly, the invention provides a base station of a wireless network, comprising a processor configured to:

estimating a propagation delay with the user equipment;

determining a compensated reference time representing an arrival time of an associated reference system frame at the user equipment, said compensated reference time including the propagation delay;

sending the compensated reference time and the associated reference system frame to said user equipment, for updating the time counter.

The base station has the same advantages as the method defined above.

Optional features of the invention are defined in the appended claims. Some of these features are explained here below with reference to a method, while they can be transposed into system features dedicated to a base station of a wireless network according to the invention.

According to some embodiments, the method may further comprise:

determining whether a new estimation of a propagation delay with the user equipment occurs during transmission of the reference system frame

According to some embodiments, in case of positive determining, the method may further comprise sending a timing advance command regardless of the amplitude of the newly estimated propagation delay.

According to some embodiments, the timing advance command may be sent using a Control Element compliant with the MAC Control Element format described in TS 38.321, which comprises a command field of at least 13 bits to encode the timing advance command.

According to some embodiments, in case of negative determining, the method may further comprise sending a timing advance command when the new estimation of a propagation delay is greater than a predetermined threshold.

According to some embodiments, the predetermined threshold may be based on the previously estimated propagation delay.

According to some embodiments, the timing advance command may be sent using a Protocol Data Unit selected from Random Access Response MAC Protocol Data Unit, Absolute Timing Advance Command MAC Control Element and Timing Advance Command MAC Control Element, all defined in TS 38.321.

According to another aspect of the invention there is provided a method of updating a time counter of one user equipment in a wireless network comprising at least one base station and a plurality of user equipment, the method comprising at the base station:

determining a reference time representing a transmission time for a reference system frame;

sending the reference time and sending the reference system frame at the transmission time, to said user equipment, for updating the time counter;

wherein, responsive to the transmission of the reference system frame:
estimating a propagation delay with the user equipment, and
sending, to the user equipment, a timing advance command including at
least a parameter based on the estimated propagation delay.

Thus, this method enables the UE to adjust its recently updated time counter upon the reception of a timing advance command just after the reference system frame. This makes it possible to consider a more accurate evaluation of the propagation delay, hence to obtain a better synchronization of the UE with the GM clock.

Correspondingly, the invention provides a base station of a wireless network, comprising a processor configured to:

determining a reference time representing a transmission time for a reference system frame;

sending the reference time and sending the reference system frame at the transmission time, to said user equipment, for updating the time counter;

wherein, responsive to the transmission of the reference system frame:
estimating a propagation delay with the user equipment, and
sending, to the user equipment, a timing advance command including at
least a parameter based on the estimated propagation delay.

The base station has the same advantages as the method defined above.

Optional features of the invention are defined in the appended claims. Some of these features are explained here below with reference to a method, while they can be transposed into system features dedicated to a base station of a wireless network according to the invention.

According to some embodiments, the timing advance command may be sent using a Control Element compliant with the MAC Control Element format described in TS 38.321, which comprises a command field of at least 13 bits to encode the timing advance command.

The present invention also provides a computer program product for a programmable apparatus, the computer program product comprising a sequence of instructions for implementing a method as described hereinbefore, when loaded into and executed by the programmable apparatus.

Besides, the invention also provides a non-transitory computer-readable storage medium storing instructions of a computer program for implementing a method described hereinbefore.

At least parts of the methods according to the invention may be computer implemented. Accordingly, the present invention may take the form of an entirely hardware embodiment, an entirely software embodiment (including firmware, resident software, micro-code, etc.) or an embodiment combining software and hardware aspects that may all generally be referred to herein as a “circuit”, “module” or “system”. Furthermore, the present invention may take the form of a computer program product embodied in any tangible medium of expression having computer usable program code embodied in the medium.

Since the present invention can be implemented in software, the present invention can be embodied as computer readable code for provision to a programmable apparatus on any suitable carrier medium. A tangible, non-transitory carrier medium may comprise a storage medium such as a floppy disk, a CD-ROM, a hard disk drive, a magnetic tape device or a solid state memory device and the like. A transient carrier medium may include a signal such as an electrical signal, an electronic signal, an optical signal, an acoustic signal, a magnetic signal or an electromagnetic signal, e.g. a microwave or RF signal.

### BRIEF DESCRIPTION OF THE DRAWINGS

Embodiments of the invention will now be described, by way of example only, and with reference to the following drawings in which:

FIG. 1 illustrates an 5G network interconnecting connected objects;

FIG. 2 is a diagram illustrating an example of architecture of a base station of the illustrated 5G network of FIG. 1;

FIG. 3 is a diagram illustrating an example of architecture of a user equipment of the illustrated 5G network of FIG. 1;

FIG. 4 illustrates a system frame of a 5G network;

FIG. 5 illustrates mechanisms of the prior art for updating the timer of a user equipment;

FIG. 6 illustrates a method implemented by the base station according to the first embodiment of the invention;

FIGS. 7 and 9 illustrates a method implemented by the base station according to a second embodiment of the invention;

FIGS. 8 and 10 illustrates a method implemented by the user equipment according to the second embodiment of the invention;

FIG. 11 illustrates a method implemented by the base station according to a third embodiment of the invention;

FIG. 12 illustrates a method implemented by the user equipment according to the third embodiment of the invention;

FIG. 13 illustrates a Protocol Data Unit of a MAC Control Element format destined to encapsulate a new Timing Advance Command; and

FIG. 14 illustrates an Absolute Timing advance command destined to encapsulate a Timing Advance Command.

### DETAILED DESCRIPTION OF THE INVENTION

The names of the lists and elements (such as data elements) provided in the following description are only illustrative. Embodiments are not limited thereto and other names could be used.

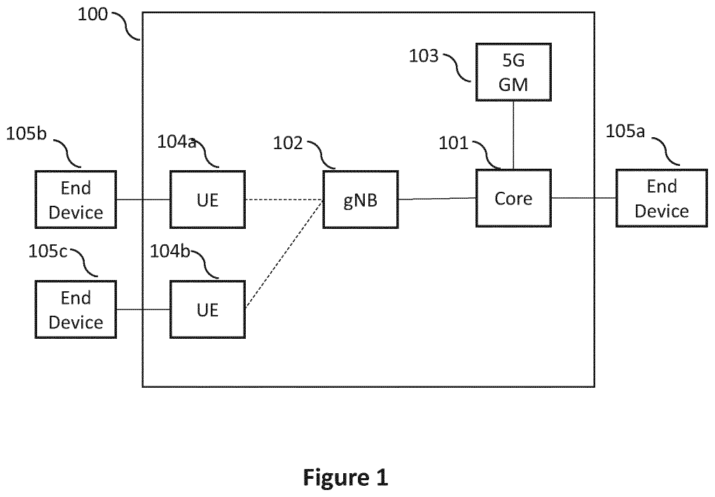

The embodiments of the present invention are intended to be implemented in 5G network used for interconnecting connected objects or terminals as the one illustrated in FIG. 1.

The 5G network 100 comprises a plurality of user equipment (UE) 104a, 104b also called mobile stations, wirelessly connected (indicated by the dotted lines) to at least one base station 102 (gNB or gNodeB). The gNB 102 is connected to a core network 101, for instance wirely (using fiber-optic) or wirelessly.

In this 5G network, a common time reference is provided by a Grand Master clock (5G GM) 103, and precisely defined in TS 23.501 clause 5.27.

The 5G GM clock may be connected to the core network 101, as illustrated in FIG. 1, but may be also directly connected to the gNB or to one of the UE. Thus, the device connected with the 5G GM clock shares with other devices of the network, the common time reference provided by the 5G GM clock.

According to some embodiments, the common time reference provided by the GM clock may be the universal time reference or based on it. In this case, the universal time reference may be obtained by the gNB directly from a satellite system. The 5G network 100, as explained before, may be used in order to connect end devices 105a, 105b and 105c, e.g. the connected devices of an IoT network. The end devices may be for example devices for industrial appliances, such as sensors and actuators. As visible in FIG. 1, the end devices 105a, 105b and 105c are connected to the UEs 104a, 104b or the network core 101 of the 5G network 100. According to some embodiments, the end devices 105a, 105b and 105c are wired to the UEs 104a, 104b or the network core 101.

According to some embodiments, one end device and one UE may be integrated within a device.

Thus, the end devices 105a, 105b and 105c share data using the 5G network. When implementing time sensitive applications in the IoT network, an accurate time synchronisation between the UEs is mandatory, in particular within the 5G network.

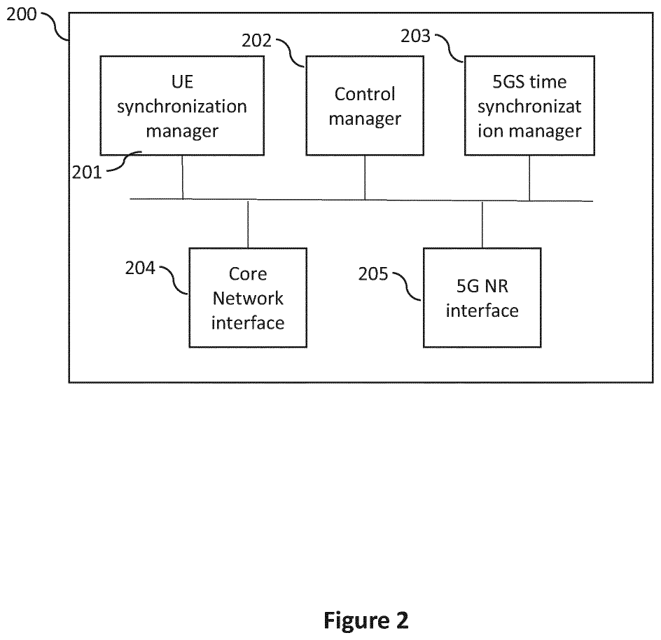

The internal architecture of the gNB 102 is illustrated in FIG. 2 by means of a diagram.

The gNB 200 comprises 5G NR interface 205 allowing it to communicate with the UEs 104a, 104b of the 5G network 100. The gNB may also comprise several different types of radio interfaces, such as LTE (4G) or other types of radio interfaces.

In order to communicate with the core network 101, the gNB also comprises a core network interface 204, as defined in TS 23.501 clause 4.2.

The synchronisation of the gNB with the 5G GM clock is handled by a 5G time synchronisation manager 203.

According to some embodiments, the 5G time synchronisation manager 203 implements a time counter incremented by a local clock oscillator. The 5G time synchronisation manager 203 continuously evaluates the clock difference between the time counter and the 5G GM clock. The evaluation may be done using the IEEE 1588 Precise Time Synchronisation Protocol implemented through the exchange of time synchronisation packets with the 5G GM through the Core Network Interface 204. The evaluated difference thus enables the 5G time synchronisation manager 203 to determine a value to adjust its time counter.

According to some embodiments, 5G time synchronisation manager 203 continuously evaluates the clock difference between the time counter and the reference time received from a satellite system such as the GPS.

Thus, the 5G time synchronisation manager 203 provides a current time to the UE synchronisation manager 201 based on its local time counter.

The UE synchronisation manager 201 is configured to handle the synchronisation between the base station and the UEs 104a, 104b of the network 100 with a view of having the time counters of all these devices be synchronized as precisely as possible.

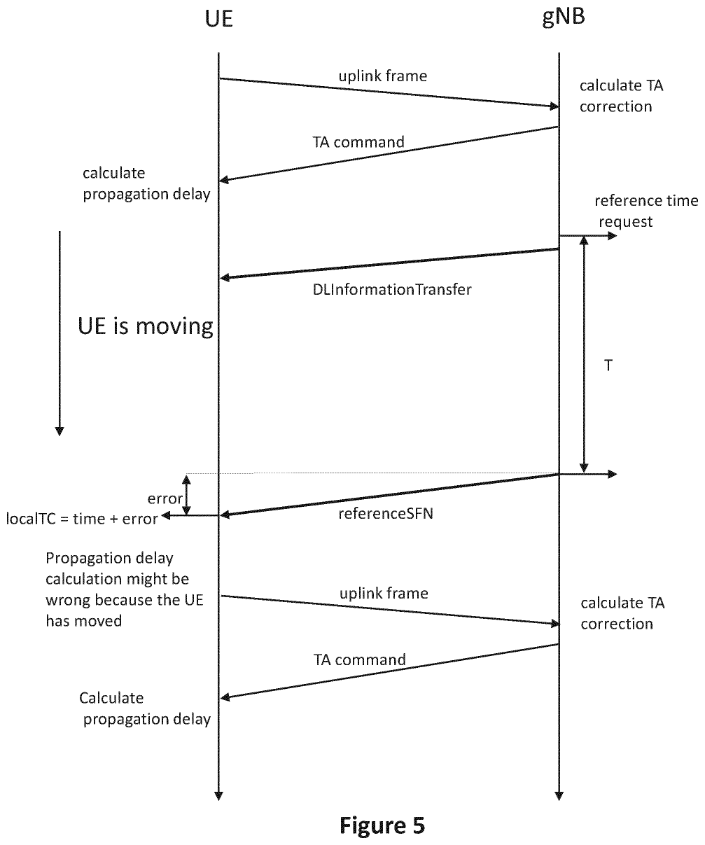

To that end, the UE synchronisation manager 201 may implement several mechanisms, as the ones described hereinafter in relation with FIG. 5. The UE synchronisation manager 201 is also configured to evaluate and record propagation delays between the gNB and each UE 104a, 104b, for synchronization purposes.

The gNB further comprises a control manager 202 in which the gNB control protocols are implemented. The control protocols comprise at least the following protocols: RLC (Radio Link Control TS 38.322), PDCP (Packet Duplication Control Protocol TS 38.323), RRC (Radio Resources Control TS 38.331) and NAS (Network Access Stratum TS 24.501). The control manager 202 thus handles the generation of the protocol packets exchanged with the core network 101 and the UEs through respectively the Core network interface 204 and the 5G NR interface 205.

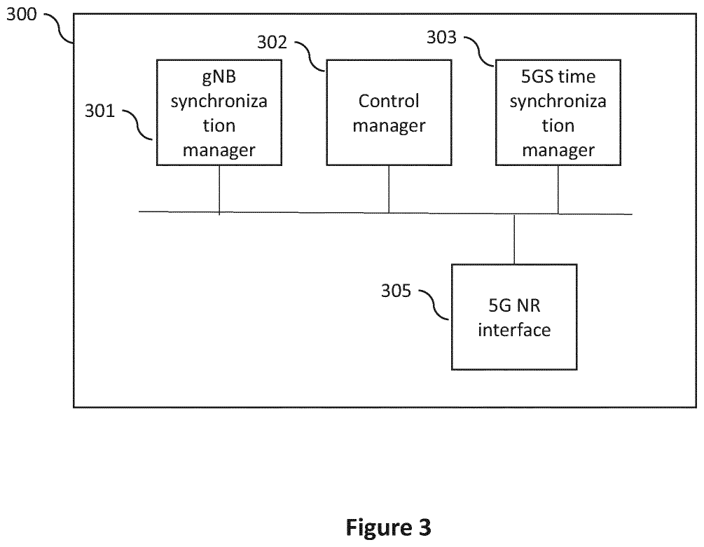

The internal architecture of the UEs 104a, 104b is illustrated in FIG. 3 by means of a diagram.

The UE 300 comprises a 5G NR interface 305 allowing the UE 300 to communicate through this interface with the gNB 200, 102. The UE 300 may comprise several different types of radio interfaces, such as LTE (4G) or other types of radio interfaces.

The synchronisation of the UE with the 5G GM clock is handled by a 5G time synchronisation manager 303.

According to some embodiments, the 5G time synchronisation manager 303 implements a time counter incremented by a local clock oscillator. The 5G time synchronisation manager 303 may correct or change the time counter value when receiving time counter corrections from the gNB synchronisation manager 301.

Indeed, the gNB synchronisation manager 301 stores parameters required for the synchronisation provided by the gNB 102 and determined by UE synchronisation manager 201 of the gNB 102. Besides, the gNB synchronisation manager 301 is also configured to evaluate and record propagation delays between the UE 300 and the gNB 102.

The UE 300 further comprises a control manager 302 in which the gNB control protocols are implemented. The control protocols comprise at least the following protocols: RLC (Radio Link Control TS 38.322), PDCP (Packet Duplication Control Protocol TS 38.323), RRC (Radio Resources Control TS 38.331) and NAS (Network Access Stratum TS 24.501). The control manager 302 the generation of the protocol packets exchanged with the gNB 200, 102 through the 5G NR interface 305.

Data exchanged through 5G NR interfaces 205, 305 between the gNB and the UEs of the network 100 comply with a frame format specified by 3GPP NR PHY and MAC protocols, defined in TS 38.300 clause 5 and 6.

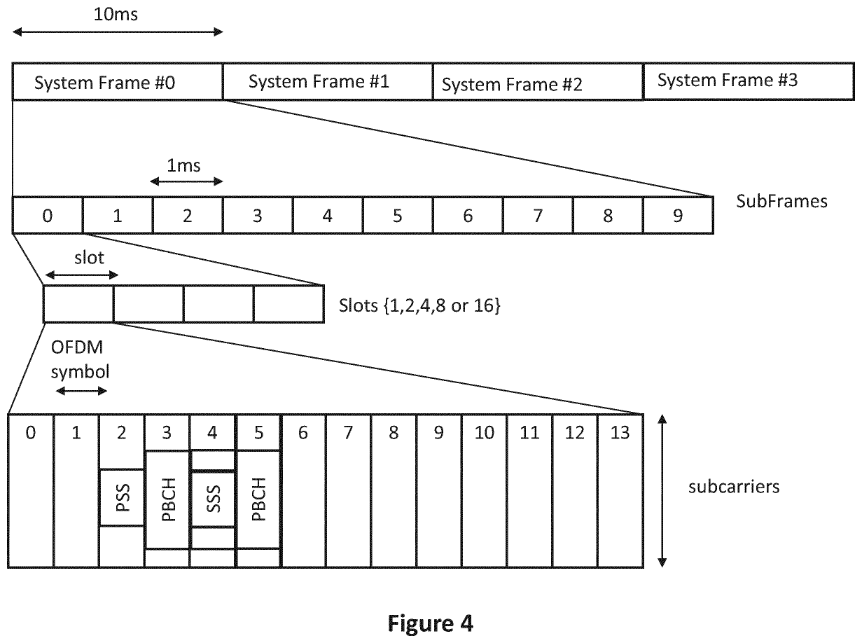

The exchanged frames, referred to as system frames hereinafter, are timely organized and have a structure as illustrated in FIG. 4.

The system frames follow each other temporally, one after the other. Each system frame has a duration of 10 ms.

The system frames may be numbered with a System Frame Number (SFN), also called an index of the System Frame. As visible, on FIG. 4, the first system frame numbered #0 is followed by the system frames #1, #2 and #3. The numbering of the system frame may be done in increments, as shown in FIG. 4. In other words, every 10 ms, the system frame number is incremented and may goes from 0 to 1023, and once 1023 is reached, the numbering starts again from 0.

Thus, the gNB numbers the system frames with SFNs. The SFNs are signalled to the UEs using System Frame Synchronization Signal. The System Frame Synchronization Signal is periodically sent by the gNB to the UEs, by signalling the SFN using six most significant bits of a so-called MIB (Master Information Block) field in the transmitted system frames and the four least significant bits of a so-called PBCH field in the transmitted system frames.

Each system frame comprises ten sub-frames ranges from 0 to 9.

Each sub-frame comprises a flexible number of slots, e.g. up to 64 slots. Each slot comprises several orthogonal frequency-division multiplexing (OFDM) slots. Each slot is made up to 14 OFDM slots.

Thus, the system frame constitutes a reference common to the UEs and the gNB. Therefore, system frames, in particular their SFNs, are used for a conventional adjustment of the time counters of the UEs.

The conventional time counter adjustment of a UE is illustrated in FIG. 5.

The conventional time counter adjustment relies on the supplying of a reference time value (T_{R}) to the UE for updating its time counter. The reference time value corresponds to the transmission time of a system frame used as reference. It is below called reference system frame.

After receiving from the UE a request for a reference time value to update its time counter, or spontaneously, the gNB selects a future reference system frame during which the gNB will compel the UEs to update their time counter with the reference time value provided by the gNB.

The reference time value may be for example the intended start or end time of transmission by the gNB of the system reference frame.

According to some embodiments, the reference time value is a projected or intended value of the time counter of the gNB corresponding to the intended start or end transmission time of the reference system frame by the gNB.

As visible on FIG. 5, the reference time is equal to the sum of:
the current time of the time counter of the gNB, that is continuously synchronized with the 5G GM clock thanks to synchronization manager 203; with
the duration T which represents the delay (in time counter units) the gNB will wait before transmitting the reference system frame to the UE.

According to some embodiments, the reference time may be for example determined by the gNB as the sum of:
the current time of the time counter of the gNB that is synchronized to the 5G Grand Master clock thanks to synchronization manager 203;
the remaining time before the beginning of the next system frame. As a new system frame occurs every 10 ms, the remaining time may be obtained by the means of an alarm counter set to 10 ms at each start of system frame, and
10 ms*(referenceSFN−nextSFN), where reference is the SFN of the designated reference system frame and nextSFN is the SFN of the next system frame. Note that referenceSFN can be nextSFN is the reference time is calculated just before transmitting the reference system frame and the reference time is included in the reference system frame, which is the case if a SIB9 message is used. Usually, referenceSFN refers to a reference system frame in the future, i.e. referenceSFN−nextSFN>0.

Reference time T_{R} and an indication of the reference system frame, referenceSFN for example, are then provided to the UEs. Both of these elements may be sent together or separately.

According to some embodiments, the gNB prepares an Information Element (referenceTimeInfo IE) containing reference time T_{R} and referenceSFN. The referenceTimeInfo IE is then encapsulated in a System Information (SI) or Radio Resource Control (RRC) messages, such as SIB9 or DLInformationTransfer messages.

DLInformationTransfer message is transmitted prior to the reference system frame, as shown in FIG. 5.

The reference system frame of the SIB9 type directly includes the reference time T_{R}. Thus, no other message in relation with the reference system frame is transmitted before by the gNB.

As shown in FIG. 5, the gNB thus sends the message to the requesting UE or to several UEs if the message is a broadcast.

In case a DLInformationTransfer message is transmitted, later on, the reference system frame is generated by the gNB when its time counter is equal to the reference time, and it transmits the reference system frame to the UEs.

Once the reference system frame is detected by the UE(s) thanks to the referenceSFN, the UE (its managers 301 and 302) which has previously received the reference time (or retrieves the reference time from the SIB9 reference system frame), sets its time counter to the reference time.

In the particular case of SIB9, the reference time corresponds to the end boundary of the system frame.

As visible on FIG. 5, there is however a delay between the instant when the gNB transmits the reference system frame and the instant when the UE receives the reference system frame. This delay, also called the propagation delay, represents the time of propagation of the radio signals between the UE and the gNB.

Thus, the above-described synchronization mechanism relies on the assumption that the propagation delay of the reference system frame, used as a trigger by the UE to set its local time counter with the reference time supplied by the gNB, is negligible.

One can understand that a permanent synchronisation error due to propagation delays is introduced when the UE set its time counter using the reference time provided by the gNB. This may not be not compatible with some applications (for instance Time Sensitive applications), in particular applications requiring a precise timestamp of the arrival or departure time of some packets. Indeed, the permanent synchronisation error due to propagation delay introduces an error in the timestamping of those packets and that may be incompatible with the requirements of the time sensitive applications.

In order to overcome this drawback, a Timing Advance Mechanism described in TS 38.211 clause 4.3 is used to correct or compensate this error in the conventional time counter adjustment of the UE.

The Timing Advance (TA) Mechanism may be used to enable the propagation delay to be calculated by the UEs, as illustrated in FIG. 5.

Originally, TA Mechanism is used by the gNB to control the timing of the UEs uplink frames. To do that, the gNB provides to the UE a TA command, comprising several parameters. These parameters, including a TA parameter, enable the UE to determine the time T_{TA} before the next gNB downlink frame at which the UE should start transmitting its uplink frame.

TA commands are provided by the gNB to the UE through the 5G NR interface. For the transmission, TA commands are encapsulated in different types of Protocol Data Unit (PDU), of the following types, all defined in TS 38.321:
Random Access Response MAC Protocol Data Unit (PDU) as defined in TS 38.321, clauses 6.1.5 and 6.2.3
Absolute Timing Advance Command MAC Control Element or Timing Advance Command MAC Control Element, defined in TS 38.321, clause 6.1.3.4 and 6.1.4a

According to the type of TA command, the parameter provided are of different nature. In the case of the Random-Access Response and the Absolute Timing Advance Command, an absolute value of the parameter TA is provided. In the case of the Timing Advance Command, only a correction of a previously provided TA is included in the TA command.

Thus, according to some embodiments, the TA command may comprise an absolute value of TA in a TA command field, that is then used by the UE to determine the instant T_{TA} according to the following formula:

T_{TA}=(N_{TA}+N_{TA,offset})*T_{C}, where

N_{TA}=TA*16*64/2^{μ} and μ is the subcarrier spacing configuration, Δf=2μ*15 kHz as defined in TS 38.211, clause 4.2, Table 4.2-1,

N_{TA,offset} is a fixed offset used to calculate the timing advance,

T_{C} is the Basic time unit for the New Radio as defined in TS 38.211, clause 4.1.

According to other embodiments, the TA command may comprise a correction, referred to as TA_{correction}, of a previously provided TA value, TAₚᵣₑᵥᵢₒᵤₛ. In this case, the adjustment to be applied to previous T_{TA} is equal to (TA_{correction}−31)*16*64/2^{μ}.

Thus, in order to control the UE uplink timing, the gNB sends TA commands in control messages to the UEs of the network. A TA command is specific to a given UE because it mirrors the propagation delay with this specific UE. Next, the UE applies the previously detailed formula to calculate T_{TA}.

Interestingly, one may notice that the member N_{TA} is proportional to the round-trip time between the gNB and UE. Such a value N_{TA} may help to determine the propagation delay, assuming that the propagation delay is symmetrical. For instance, the propagation delay between the UE and gNB is equal to (N_{TA}*Tc)/2.

This way, when receiving a TA command, the UE may be able to determine the propagation delay during the transmission of the TA command. The calculated propagation value may be then used when adjusting the time counter as described hereinbefore, using the reference time and the reference system frame sent by the gNB.

As visible on FIG. 5, a first TA command is received from the gNB and is used by the UE to calculate a propagation delay. Next, when the reference system frame is detected, the time counter is set using the reference time T_{R} adjusted with the calculated propagation delay. For instance, the time counter is set to a value corresponding to T_{R} plus the propagation delay.

One problem occurs when the UE moves between the reception of the TA command from the gNB and the adjustment of its time counter.

Indeed, although the gNB continuously monitors the propagation delay of the UE uplink frames, the gNB sends subsequent TA command when the arrival times shifts significantly compared to the expected arrival time, i.e. when the propagation delay increases significantly since the last transmitted TA command. And also the gNB is responsible for keeping the uplink synchronization through TA update triggering. Uplink synchronization have different requirements than those needed for time synchronization purpose. So, for example, a predetermined threshold may be used to determine whether or not a subsequent TA command should be sent in order to compensate an increase of the propagation delay. It turns out that no TA command may be transmitted for a while before the UE significantly moves, significantly modifies the propagation delay and a subsequent TA command is transmitted by the gNB.

However, the subsequent TA command may be sent and received after the conventional time counter adjustment of the UE while the UE has moved before the reference system frame has been transmitted. By the way this situation is illustrated on FIG. 5. In that case, the time counter of the UE has been adjusted using the old propagation delay and thus comprises a synchronisation error. This is because the old propagation delay does not reflect the real position of the UE when receiving the reference system frame from the gNB.

There is thus a need to provide to UE or the gNB a way to evaluate a propagation delay that reflects as best as possible the position of the UE, when the UE receives the reference system frame from the gNB, in order to compensate the propagation delay when updating the time counter of the UE.

The present invention thus proposes that the UE, in response to receiving a timing advance command from the base station, updates the time counter of the user equipment using the timing advance command.

In that way, there is no longer the need for the UE to wait for the next reference system frame before adjusting its time counter based on a received TA command. Should the TA command be received soon after the prior art time counter adjustment, the time counter adjustment in response to the TA command indeed accurately mirrors the true propagation delay given the current UE location and network conditions.

Thus, the invention enables the UE to take into consideration a TA command as soon as it is received, even after the conventional update of the time counter of the UE, to calculate the propagation delay and to use the calculated value of the propagation delay for adjusting the time counter of the UE.

As explained hereinbefore, the timing advance command includes a parameter TA representative of a propagation delay between the base station and the user equipment. For example, the parameter is an absolute value of TA or a corrected value of TA, that can be use by the UE to determine the propagation delay.

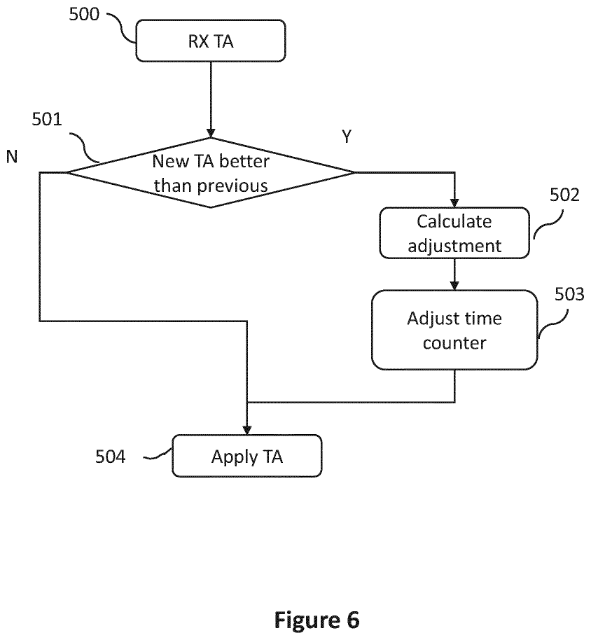

Several embodiments are proposed within the document, and are illustrated from FIGS. 6 to 12.

A first embodiment of the invention is illustrated in FIG. 6. The illustrated method occurs at the UE side, when the UE is receiving TA commands from the gNB.

In this embodiment, the UE determines whether the timing advance command is more accurate than the previously received timing advance command, based on a comparison criterion, and triggers the updating of its time counter in case of positive determining only.

First, the UE receives a TA previous command from the gNB (not illustrated), as the one described in reference to FIG. 5.

Then, the UE receives a reference system frame emitted by the gNB. As explained hereinbefore, the reference system frame is used in the conventional time counter adjustment for updating the time counter of the UE.

As explained hereinbefore, when detecting the reference system frame, the UE updates its time counter by setting it at the sum of the reference time T_{R} provided by the gNB for the reference system frame and an estimated propagation time calculated using the previous TA command.

Next, at step 500, the UE receives a new TA command. Upon the receiving of the TA command, the UE determines at step 501 whether the timing advance command is more accurate than the previous timing advance command, based on a comparison criterion.

According to some embodiments, the comparison criterion may be of different types. For example, the comparison criterion may mirror which of the timing advance commands (previous and new) is temporally the closest to the reference system frame. For example, the comparison may be comparing a first elapsed time between the reference system frame and the previous timing advance command and a second elapsed time between the reference system frame and the new timing advance command. If the first elapsed time is greater than the second elapsed time, then the new TA command is considered as more accurate than the previous TA command.

For example, the comparison may be comparing the SFNs of the system frames (the reference one and the ones including the TA commands). As explained hereinbefore, the previous TA command is sent previously to the reference system frame, in a previous system frame having a SFN, SFNₚᵣₑᵥᵢₒᵤₛ. Similarly, the new TA command may be sent after the reference system frame, during a subsequent system frame having a SFN, SFN_{new}. In order to determine the closest TA command, it may be easily done by comparing the SFN distances between the respective system frames: SFN_{reference}−SFNₚᵣₑᵥᵢₒᵤₛ compared to SFN_{reference}−SFN_{new}. To do that, each time a TA command is received and then applied, the SFN of the TA command may be stored by the UE.

According to other embodiments, the comparison criterion may also include a criterion based on the signal strength of the received system frames (including the reference system frame and the frames conveying the timing advance commands). Indeed, based on the measured signal strength, it may be possible to determine which one of the provided timing advance TA mirrors the more accurately the UE positioning regarding the base station. Again, the TA command provided in the system frame having the closest signal strength to the one of the reference system frame can be considered as being the more accurate one.

According to the result of step 501, the updating of the time counter can be triggered.

Thus, when the new TA command is considered to be more accurate than the previous TA command, the UE shall then update the previously updated time counter with the new TA command. The updating requires the calculation (step 502) of an adjustment of the time counter considering the new propagation delay.

The adjustment value calculation depends on the type of new TA command.

If new TA command is either a Random-Access Response or an absolute timing advance command MAC CE, it comprises thus an absolute value of TA, and then the adjustment value is equal to T_{C}*(N_{TA_new}−NT_{A_previous})/2, where N_{TA_new} is calculated using the absolute TA value of the new TA command, as explained hereinbefore in relation with FIG. 5. N_{TA_previous} has been stored by the UE, when receiving the previous TA command as explained hereinbefore. The adjustment value thus represents the difference between the propagation delay calculated with the previous TA command and the new TA command (as a reminder, the propagation delays corresponding to the previous and new TA commands respectively correspond to (N_{TA_previous}*Tc)/2 and (N_{TA_new}*Tc)/2).

If new TA command is timing advance command MAC CE comprising a correction TA value (and not an absolute value of TA), then the adjustment value is equal to (TA_{correction}−31)*16*64/2^{μ}, where TA_{correction} is the value of the correction TA value comprised in the newly received timing advance command.

At step 503, the UE then adjusts its time counter with the calculated adjustment value. In other words, the UE changes the time counter current value by adding the obtained adjustment value. According to some embodiments, the adjustment value will be applied by smaller adjustment values distributed along a predetermined period of time, for example following a proportional integral filter.

Then, at step 504, the TA command is applied by the UE. To do that, the UE calculates the N_{TA_new} in order to determine the T_{TA} at which the UE shall send its uplink frames. Next the N_{TA_new} is stored in the N_{TA_old} variable and the SFN of the TA command new is memorized as SFNₚᵣₑᵥᵢₒᵤₛ. These values can for instance be used to compensate the next reference time T_{R} received for the next reference system frame.

At step 501, if the new TA command is not more accurate than the previous timing advance command, based on a comparison criterion, then the UE directly performs step 504.

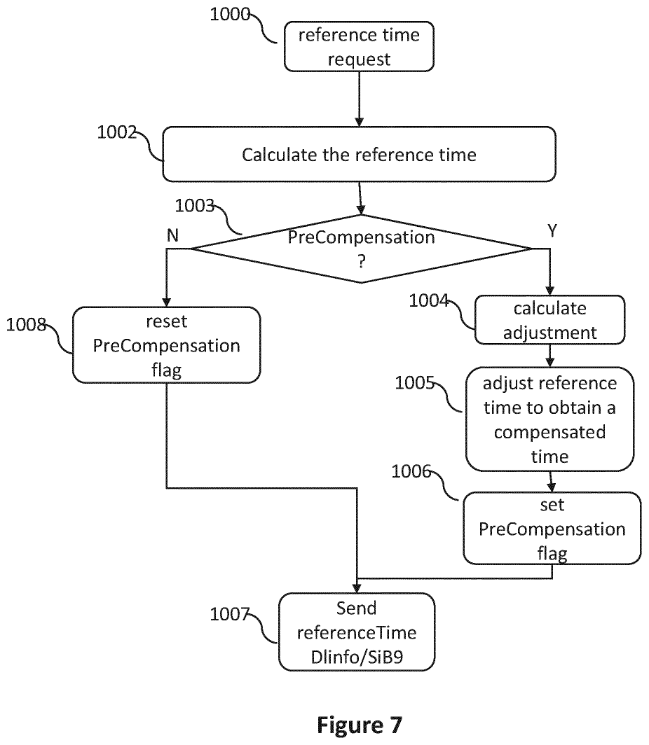

A second embodiment is illustrated in FIGS. 7, 8, 9 and 10, wherein the gNB evaluates the propagation delay with a user equipment and then provides the user equipment with a compensated reference time instead of the conventional reference time T_{R}. The compensated reference time thus includes the propagation delay specific to the UE in order to allow the time counter of the UE to be directly updated without calculating a propagation delay. In other words, the proposed embodiment aims at integrating the propagation delay in the reference time value provided by the gNB for updating the time counter of the UE.

FIG. 7 illustrates the method on the gNB side, executed by the UE synchronisation manager 201.

At the optional step 1000, the gNB receives a request for synchronisation from the UE.

As explained hereinbefore, in relation with the conventional time counter adjustment, at step 1002, the gNB calculates the reference time for the next reference system frame.

Next, the gNB checks whether it shall perform a pre-compensation of the reference time, i.e. to include therein the propagation delay in order to obtain a compensated reference time.

According to some embodiments, this test may consist for example in checking a configuration flag, indicating whether or not the gNB shall perform pre-compensation.

According to some embodiments, this test may consist in checking whether the reference time is intended to be forwarded to one UE (unicast) or several UEs (broadcast). As the pre-compensation considers a propagation delay, that is different from one UE to another, it should only be done when the reference is intended to one UE.

In the case when the gNB shall perform a pre-compensation, at step 1004, the gNB evaluates the propagation delay using the last calculated and sent TA and the following formula:

(T_{TA}−Tc*N_{TA,offset})/2, where T_{TA} is the timing advance between downlink and uplink frames. Indeed, T_{TA} is continuously determined by the gNB, which then calculates TA to be sent within a TA command. Thus, the determining of the compensated reference time is performed after the sending of a TA command by the gNB.

Next, at step 1005, the gNB determines the compensated reference time, by adjusting (sum) the reference time with the calculated propagation delay.

The calculated propagation delay is stored as previousPropagationDelay.

According to some embodiments, at step 1006, a pre-compensation flag (a Boolean field) associated with the referenceTimeInfo Information Element of the DLInformationTransfer or SIB9 messages may be provided. Thus, when a compensated reference time has been determined, then the flag is set to TRUE. Otherwise, the flag is set to FALSE. This is to signal the UE that the provided reference time is compensated or not.

Next, at step 1007, a DLInformationTransfer or SIB9 message is sent, including:
the reference time when no pre-compensation has been made;
the compensated reference time, including the propagation delay, when pre-compensation has been made by the gNB.
The reference system frame is then sent if necessary (DLInformationTransfer case).

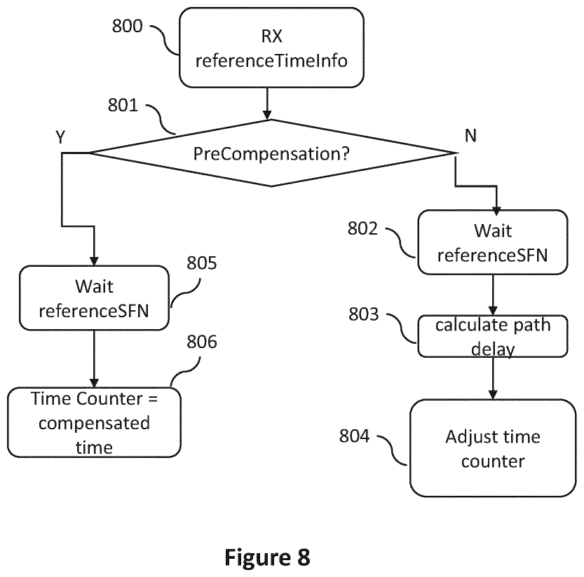

Next, the UE receives the messages. They are processed according to the illustrated method of FIG. 8, performed by the gNB synchronisation manager 301 of the UE.

After receiving the DLInformationTransfer or SIB9 message at step 801, the UE checks the pre-compensation flag of the received message to determine whether or not the message comprises a compensated reference time or a reference time.

When a pre-compensation has been performed by the gNB, the UE waits for the reference system frame (step 805) and upon receiving it, it updates its time counter with the provided compensated reference time (806).

When no pre-compensation has been performed by the gNB, the conventional process is made: the UE waits for the reference system frame (step 802). Next at step 803, the UE determines the propagation delay using the last applied TA command. The propagation delay is calculated as T_{C}*NT_{A_old}/2 as explained hereinbefore (in relation with FIG. 6) where the value NT_{A_old} is retrieved from the UE storage.

Using the calculated propagation delay, the gNB synchronization manager 301 instructs the 5G time synchronization manager to set (804) the time counter to the sum of the reference time and the calculated propagation delay.

This mechanism of pre-compensation may be used alone or together with the principle of the first embodiment (described in relation with FIG. 5) as shown in Figure for example, i.e. the updating of the time counter upon the receiving of a TA command from the gNB.

According to some embodiments, pre-compensation is systematically done by the gNB, such that on the UE side, when receiving the pre-compensation, the UE applies systematically steps 805 and 806, previously described in reference to FIG. 8.

The gNB must have a valid TA value to be used for pre-compensation when sending the reference time to the UE. A valid TA value is obtained after a random access by the UE and subsequent uplink transmissions by the UE.

In case the gNB does not have a valid TA value at the time of the pre-compensation it is necessary to specify a dedicated signaling that will allow the gNB to send path delay information correction after the reference time have been sent.

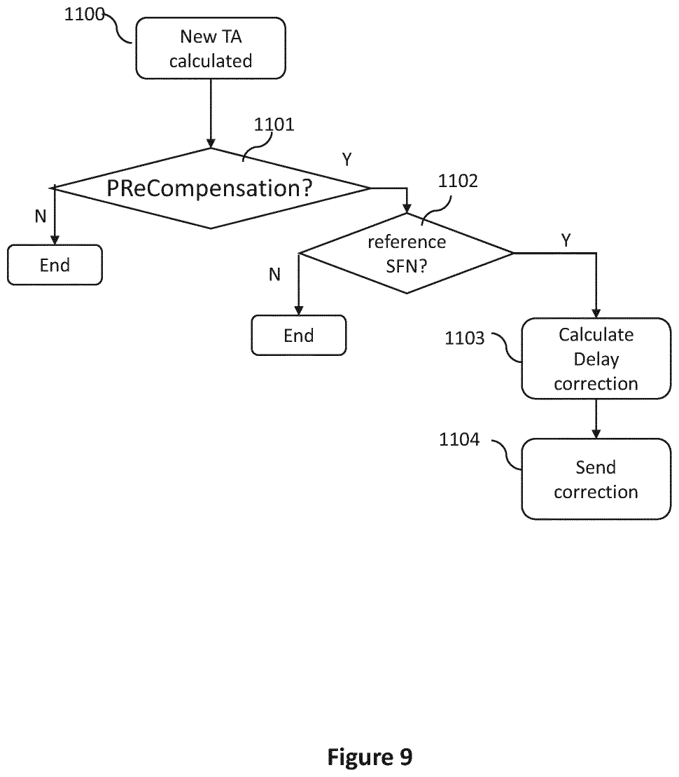

The method illustrated in FIG. 9, allows the sending of a propagation delay correction by the gNB using a TA command according to embodiments of the invention.

Thus, upon detection of an SFN event, the gNB can use a new signaling to send a correction of the propagation delay to the UE.

The method takes place during the transmission of the reference system frame.

The method is executed by the UE synchronization manager 201, when a new TA value is determined for a UE. Indeed, the gNB continuously determines T_{TA} values when exchanging frames with a UE. These determined T_{TA} s do not always lead to the generation of a TA command, especially when the calculated TAs from the determined T_{TA} s have a value close to the TA of the latest generated TA command. According to some embodiments, a new TA command is generated when the difference between the previous T_{TA} command and new T_{TA} is greater than a predetermined threshold.

At step 1101, the gNB checks whether a pre-compensation has been performed by the gNB for the UE. In other words, the gNB determines whether the sent reference time was compensated or not.

In case of positive determining, at step 1102, the gNB checks whether the evaluation of the new TA occurred during the transmission of the reference system frame associated with the compensated reference time.

If the current system frame is the reference system frame, then the gNB, at step 1103, uses the new T_{TA} in order to calculate a correction of the propagation delay with respect to the propagation delay, previousPropagationDelay, estimated when determining the compensated reference time (i.e. at step 1005).

The correction of the propagation delay (CorrectionPropagationDelay) is calculated using the following formula:

CorrectionPropagationDelay=(T_{TA}−T_{C}*N_{TA,offset})/2—previousPropagationDelay, where the previousPropagationDelay is the value of the propagation delay memorized at step 1005 of the method illustrated in FIG. 7. It should be noted that CorrectionPropagationDelay is a signed value, because the correction must indicate whether the UE has to increase or decrease the current value of its time counter.

Once the correction of the propagation delay is obtained, at step 1104, the gNB sends the correction of the propagation delay to the UE, through the 5G NR interface 205.

To do that, the gNB may use several types of the TA command PDU, either the Timing Advance Command MAC CE, previously introduced, or a new type of timing command MAC CE, herebelow referred to as delay correction MAC CE message.

The delay correction MAC CE is a PDU of a MAC CE format compliant with TS 38.321, which comprises a command field (to encode the TA value) of at least 13 bits to encode the timing advance command.

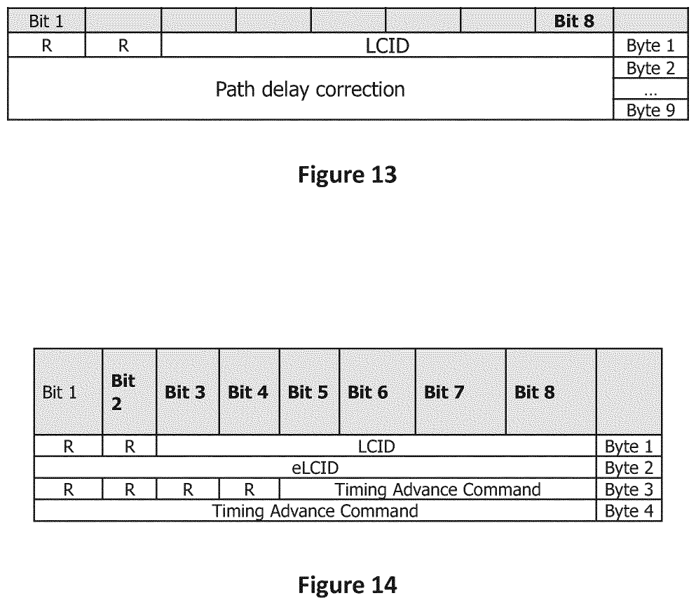

An exemplary format of the delay correction MAC CE message is illustrated in FIG. 13. It is compliant with the MAC CE format described in TS 38.321 clause 6.1.3. The first byte comprises two reserved bits (R) and a logical channel id (LCID) whose value can be any value between 35 and 46. The eight bytes from byte 2 to byte 9 encode the propagation delay correction (TA value) as a 64 bits integer.

Of course, other bit lengths to encode the TA value may be contemplated, preferably four or six bytes.

When a Timing Advance Command MAC CE is sent, the value of TA_{correction} is calculated according the following formula:

TA_{correction}=(CorrectionPropagationDelay+31)*2^{μ}/16*64.

When a delay correction MAC CE message is sent, the Propagation Delay Correction field of the delay correction MAC CE message is set to the propagation delay correction calculated at step 1103. Such a message has the benefit to be able to carry the correction in a larger bit field (64 bits). This enables a greater range of correction values to be handled.

According to some embodiments, the gNB may decide to send the TA command to the UE independently to the amplitude of the calculated correction of the propagation delay, i.e. without comparing it to a threshold value. According to some embodiments, the calculated propagation delay correction is sent to the UE within a delay correction MAC CE message.

According to some embodiments, the TA commands are only sent when the amplitude of calculated correction of the propagation delay is greater than a predetermined threshold. In that case, the gNB may send the timing command using a PDU selected from the group of Random-Access Response PDU, Absolute Timing Advance Command MAC CE and Timing Advance Command MAC CE.

The process of FIG. 9 advantageously deals with the first TA command sent after a reference system frame. The use of the delay correction MAC CE format to transmit this first TA command advantageously eases the recognition of such TA command by the UE. The latter can systemically apply an updating of its time counter using such TA command because its delay correction MAC CE format guarantees it provides a close-to-reality evaluation/correction of the propagation delay.

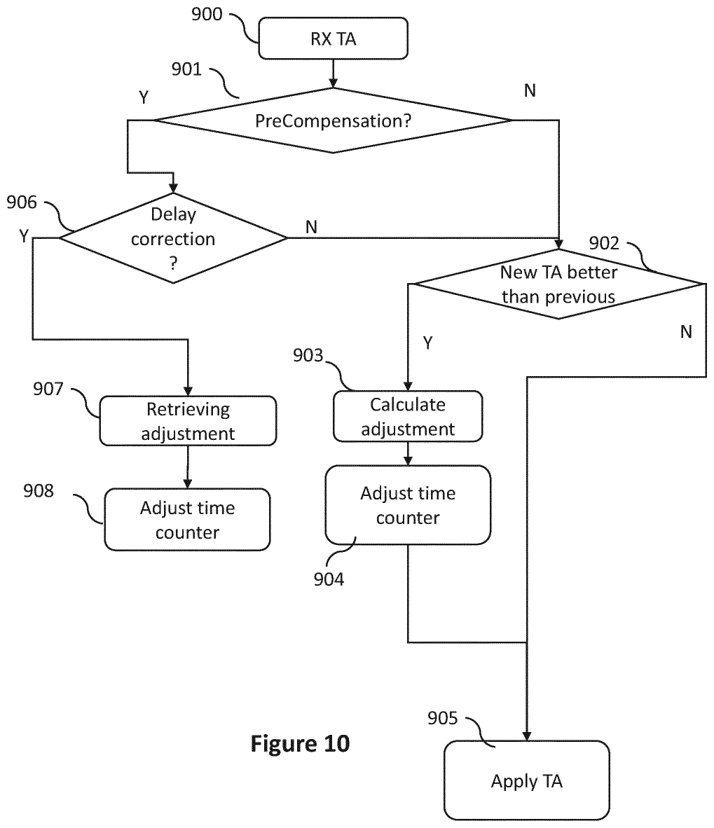

Next, the sent TA command is received by the UE, and is processed according to the illustrated method in FIG. 10.

This method is performed by the gNB synchronization manager 301 of the UE, upon the reception (step 900) of a timing advance command.

At step 901, first, the UE checks whether a pre-compensation has been performed by the gNB for the last reference system frame. This step is similar to step 801 above.

If no compensation has been made, then the UE determines (902) whether the received timing advance command is more accurate than a previous timing advance command, based on a comparison criterion, as described in relation with FIG. 6 (see step 501).

If the received TA command is less accurate than the previous TA command, the received TA command is not used to update the time counter of the UE, and is only applied in a conventional manner (step 905).

If the received TA command is more accurate than the previous timing advance command, then the adjustment is calculated (step 903) and the time counter is updated using the received TA command (904), similarly to steps 502 and 503 described in relation with FIG. 6.

If a pre-compensation has been made by the gNB, then the UE updates its time counter using the received TA command if it conveyed through a delay correction MAC CE. In other words, when pre-compensation of the reference time is done by the gNB, the update using the TA received in a delay correction MAC CE is systematically carried out without checking the relevance of the TA compared to a previous one.

Back to the Figure, at step 906, it is determined whether the received TA command is a delay correction MAC CE.

In the affirmative (it is the first TA command received after the reference system frame), the propagation delay correction, Correction Propagation Delay, comprised in the TA command is used to adjust the time counter of the UE. Thus, at step 907, the adjustment is set to CorrectionPropagationDelay retrieved from the delay correction MAC CE message. During step 908, gNB synchronization manager 301 of the UE instructs the 5G time synchronization manager to change the time counter value by applying the adjustment obtained at step 907, typically by adding CorrectionPropagationDelay to the current value of the time counter. Preferably, the adjustment by adding CorrectionPropagationDelay will be applied by smaller adjustments distributed along the time for example following a proportional integral filter.

In the negative (the received TA command is included in a Timing Advance Command MAC CE), then the process goes to step 902 to apply the TA command only if it is more accurate than the previously used TA command. To do that, steps 903, 904 and 905, similar to steps 501, 502, 503 and 504 described in relation with FIG. 6 are performed.

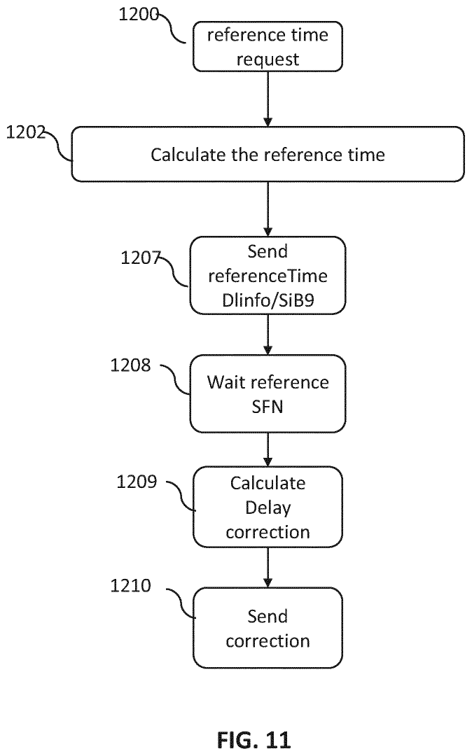

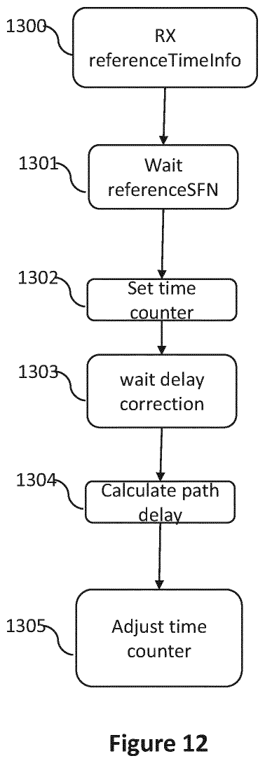

Third embodiments of the present invention are illustrated on FIGS. 11 and 12. These embodiments rely on a systematic updating of the UE's time counter with the first TA command received after a reference system frame. Indeed, it is assumed that this TA command is statistically a correct mirroring of the real propagation delay at the reference time.

In the third embodiments, when the gNB is transmitting a reference system frame, it automatically calculates a propagation delay correction (or a propagation delay) for a UE, and then provides the UE with this correction (or the value of the propagation delay) in a TA command, in order to adjust the UE's time counter recently updated (with the reference time of the reference system frame). Thus, such a method enables the systematic correction of an UE's recently updated time counter with the first TA command following the reference system frame.

FIG. 11 illustrates a method performed by the gNB, in particular the UE synchronisation manager, when a reference time is to be sent to the UE.

At step 1202, the reference time is determined in the same way as the one described at FIG. 7 (step 1004 and 1005) (or at FIG. 5).

At step 1207, the reference time is sent to the UE through the 5G NR interface 205. It may be done using DLInformationTransfer or SIB9 messages.

The gNB then waits for the reference system frame associated with the reference time.

As explained before, the gNB continuously calculates T_{TA} values. Then, at step, 1209, the gNB calculates the propagation delay with the last determined T_{TA} as (T_{TA}−T_{c}*N_{TA,offset})/2. In the best situation, the T_{TA} may have been calculated during the transmission of the reference system frame.

Next, the calculated propagation delay correction (or the propagation delay) is sent to the UE using a TA command, via the 5G NR interface 205.

According to some embodiments, a delay correction MAC CE message, or the Absolute Timing Advance Command MAC CE and the Random-Access Response may be used.

In case the delay correction MAC CE message is used to transmit relative correction and absolute TA values, a flag may be signalled in the message to indicate whether the provided TA value is relative or absolute.

An example of the Absolute Timing Advance Command MAC CE is thus illustrated in FIG. 14. The Absolute Timing Advance Command MAC CE comprises wo reserved bits (R) and a logical channel id (LCID) are set to 34. The eLICD byte is set to codepoint 252 Index 316 as defined in table 6.2.1-1b of TS 38.321. The Timing Advance Command field is 12 bits large and is calculated as TAC=(T_{TA}−Tc*N_{TA,offset})/2*2μ/16*64.

According to an alternative, the four reserved bits of the byte 3 of the absolute timing advance MAC CE can used to extend the timing advance command field of the Absolute Timing Advance Command MAC CE from 12 to 16 bits.

According to some embodiments, the TAC timing advance command is sent using a Random-Access Response, TS 38.321, clauses 6.1.5 and 6.2.3.

On the UE side, illustrated in FIG. 12, steps 1300 to 1302 are the same steps as the one implemented during a conventional time counter adjustment of the UE. Indeed, when the reference time is received at step 1300, the UE waits for the reference frame system, at step 1301, in order to update, at step 1302, the time counter with the reference time and the last TA received.

Then the UE waits for a propagation delay correction provided by the gNB (step 1303). This is the first TA command following the reference system frame.

In response to the receiving of the first timing advance command following the reference system frame (and comprising the propagation delay correction), the UE adjusts its time counter accordingly.

To that end, at step 1304, the propagation delay is obtained directly from this TA command. It is then used to adjust (step 1305) the UE's time counter, by a mere addition.

When the received is an Absolute Timing Advance Command MAC CE or a Random-Access Response, then at step 1304, the adjustment is calculated as T_{C}*N_{TA}/2. When a delay correction MAC CE message is received, the value delay correction is directly applied.

At step 130, the gNB synchronization manager of the UE instructs the 5G time synchronization manager to adjust the time counter by applying the obtained adjustment.

Besides, at step 1305, the UE calculates a new N_{TA} in order to apply the received TA command.

Thus, this method enables the UE to adjust its recently updated time counter upon the reception of a timing advance command just after the reference system frame. This makes it possible to consider a more accurate evaluation of the propagation delay, hence to obtain a better synchronization of the UE with the GM clock.

The present invention also provides a computer program product for a programmable apparatus which comprises a sequence of instructions for implementing the previously described embodiments of the invention when loaded into and executed by the programmable apparatus.

Besides, the method also provides a non-transitory computer-readable storage medium storing instructions of a computer program for implementing the previously described embodiments of the invention.

Any step of the algorithms of the invention may be implemented in software by execution of a set of instructions or program by a programmable computing machine, such as a PC (“Personal Computer”), a DSP (“Digital Signal Processor”) or a microcontroller; or else implemented in hardware by a machine or a dedicated component, such as an FPGA (“Field-Programmable Gate Array”) or an ASIC (“Application-Specific Integrated Circuit”).

Although the present invention has been described hereinabove with reference to specific embodiments, the present invention is not limited to the specific embodiments, and modifications will be apparent to a skilled person in the art which lie within the scope of the present invention.

Many further modifications and variations will suggest themselves to those versed in the art upon referring to the foregoing illustrative embodiments, which are given by way of example only and which are not intended to limit the scope of the invention, that being determined solely by the appended claims. In particular, the different features from different embodiments may be interchanged, where appropriate.

Each of the embodiments of the invention described above can be implemented solely or as a combination of a plurality of the embodiments. Also, features from different embodiments can be combined where necessary or where the combination of elements or features from individual embodiments in a single embodiment is beneficial.

In the claims, the word “comprising” does not exclude other elements or steps, and the indefinite article “a” or “an” does not exclude a plurality. The mere fact that different features are recited in mutually different dependent claims does not indicate that a combination of these features cannot be advantageously used.

1. A method of updating a time counter of one user equipment in a wireless network comprising at least one base station and a plurality of user equipment, the method comprising at the user equipment:
receiving a timing advance command from the base station;
wherein in response to receiving the timing advance command,
updating the time counter using the timing advance command.

2. The method of claim 1, wherein the timing advance command includes a parameter representative of a propagation delay between the base station and the user equipment.

3. The method of claim 1 or 2, further comprising:
receiving a previous timing advance command from the base station;
receiving a reference system frame emitted by the base station; and
responsive to receiving the reference system frame, updating the time counter using the previous timing advance command, to obtain a previously updated time counter,
wherein the updating of the time counter using the timing advance command includes updating the previously updated time counter based on the timing advance command.

4. The method of claim 3, further comprising:
determining whether the timing advance command is more accurate than the previous timing advance command, based on a comparison criterion, and
triggering the updating of the time counter using the timing advance command, in case of positive determining.

5. The method of claim 4, wherein determining whether the timing advance command is more accurate than the previous timing advance command comprises:
comparing a first elapsed time between the reference system frame and the previous timing advance command and a second elapsed time between the reference system frame and the timing advance command.

6. The method according to claim 3, further comprising:
receiving a reference time corresponding to the reference system frame,
determining whether the received reference time is a compensated reference time representing an arrival time of the reference system frame at the user equipment, said compensated reference time already including a value of a propagation delay,
wherein the time counter is updated further based on the compensated reference time.

7. The method of claim 6, wherein in case of negative determining, the method further comprises performing the updating of the time counter using the timing advance command, independently to the previous timing advance command.

8. The method of claim 6, wherein in case of negative determining, the method further comprises:
determining whether the timing advance command is more accurate than the previous timing advance command, based on a comparison criterion, and
triggering the updating of the time counter using the timing advance command, in case of positive determining that the timing advance command is more accurate.

9. The method according to claim 1, wherein the timing advance command used to update the time counter is the first timing advance command received after the reference system frame.

10. The method according to claim 1, wherein the timing advance command is received through a Protocol Data Unit from the group of Random Access Response MAC Protocol Data Unit, Absolute Timing Advance Command MAC Control Element, Timing Advance Command MAC Control Element, all defined in TS 38.321, and a Control Element compliant with the MAC Control Element format described in TS 38.321, which comprises a command field of at least 13 bits to encode the timing advance command.

11. A method of updating a time counter of one user equipment in a wireless network comprising at least one base station and a plurality of user equipment, the method comprising at the base station:
estimating a propagation delay with the user equipment;
determining a compensated reference time representing an arrival time of an associated reference system frame at the user equipment, said compensated reference time including the propagation delay;
sending the compensated reference time and the associated reference system frame to said user equipment, for updating the time counter.

12. The method of claim 11, further comprising:
determining whether a new estimation of a propagation delay with the user equipment occurs during transmission of the reference system frame.

13. The method of claim 12, wherein in case of positive determining, the method further comprises sending a timing advance command regardless of the amplitude of the newly estimated propagation delay.

14. The method of claim 11, wherein the timing advance command is sent using a Control Element compliant with the MAC Control Element format described in TS 38.321, which comprises a command field of at least 13 bits to encode the timing advance command.

15. The method of claim 12, wherein in case of negative determining, the method further comprises sending a timing advance command when the new estimation of a propagation delay is greater than a predetermined threshold.

16. The method of claim 15, wherein the predetermined threshold is based on the previously estimated propagation delay.

17. The method of claim 16, wherein the timing advance command is sent using a Protocol Data Unit selected from Random Access Response MAC Protocol Data Unit, Absolute Timing Advance Command MAC Control Element and Timing Advance Command MAC Control Element, all defined in TS 38.321.

18. (canceled)

19. (canceled)

20. A device in a wireless network comprising at least one base station and a plurality of user equipment comprising:
a processor configured to perform:
receiving a timing advance command from the base station;
wherein in response to receiving the timing advance command, updating a time counter using the timing advance command.

21. (canceled)

22. A non-transitory computer-readable storage medium storing instructions of a computer program for implementing the method according to claim 1.

23. A method of updating a time counter of one user equipment in a wireless network comprising at least one base station and a plurality of user equipment, the method comprising at the user equipment:
receiving a reference time corresponding to a reference system frame,
determining whether the received reference time is a compensated reference time already including a value of a propagation delay,
in case it is determined that the received reference time is a compensated reference time, updating the time counter using the received reference time.

24. The method of claim 23, wherein, in case it is determined that the received reference time is not a compensated reference time, the method further comprising:
compensating the received reference time, and
updating the time counter using the compensated reference time.

25. A method of updating a time counter of one user equipment in a wireless network comprising at least one base station and a plurality of user equipment, the method comprising at the user equipment:
receiving a reference time corresponding to a reference system frame,
determining whether the received reference time is a compensated reference time already including a value of a propagation delay,
in case it is determined that the received reference time is not a compensated reference time, the method further comprises:
compensating the received reference time, and
updating the time counter using the compensated reference time.

26. The method of claim 25, wherein, in case it is determined that the received reference time is a compensated reference time, the method further comprises updating the time counter using the received reference time.

27. The method of claim 24, further comprising:
receiving a timing advance command from the base station;
wherein the timing advance command includes a parameter representative of a propagation delay between the base station and the user equipment.

28. The method of claim 27, wherein compensating the received reference time uses the propagation delay included in the received timing advance command.

29. The method of claim 23, wherein the compensated reference time represents an arrival time of the reference system frame at the user equipment.

30. The method of claim 23, wherein the determining is based on a flag set by the base station.

31. A method of updating a time counter of one user equipment in a wireless network comprising at least one base station and a plurality of user equipment, the method comprising at the base station:
sending, to at least one of the plurality of user equipment, a reference time associated with a reference system frame;
sending a flag indicating whether the reference time is a compensated reference time.
